(19) United States
(12) Patent Application Publication
(10) Pub. No.: US 2009/0099914 A1
(43) Pub. Date: Apr. 16, 2009

(54) AUTOMATED TRANSACTIONAL CREDIT SYSTEM AND METHOD FOR ELECTRONIC TRANSACTIONS

(75) Inventors: Daniel J. Lang, Grove City, OH (US); Ann K. Rush, Gahanna, OH (US); David Nack, Bexley, OH (US); Jeremy Hysell, Newark, OH (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: ALLIANCE DATA SYSTEMS CORPORATION, DALLAS, TX (US)

(21) Appl. No.: 11/872,907

(22) Filed: Oct. 16, 2007

(51) Int. Cl. G06Q 30/00; G06Q 40/00; G06Q 20/00

(52) U.S. Cl. 705/14; 705/35; 705/38; 705/26

(57) ABSTRACT

In a transactional credit system and method, a consumer makes a purchase on a merchant's website. Before the consumer can select a payment option, a webpage requests that the consumer enter her name and shipping or billing address. Using this information, the system determines first whether to make an offer for a transactional credit product to the consumer and second whether the consumer pre-qualifies for the transactional credit product if the offer is to be made. If the consumer pre-qualifies, an additional webpage is incorporated into the merchant's website that offers the transactional credit product to the consumer to pay for the web-based transaction before the consumer is directed to any order confirmation or payment webpage on the website. If the consumer accepts the offer, the system performs any necessary authorizations or instant credit applications and applies the transactional credit product to the web-based transaction.

### FIELD OF THE DISCLOSURE

The subject matter of the present disclosure relates to a system and method for offering a credit product to consumers on a transactional basis when the consumer is completing a purchase for an electronic transaction.

### BACKGROUND OF THE DISCLOSURE

Consumers can purchase items on-line, via the phone, or in a retail store. Web-based purchasing has become increasingly popular, and websites are designed to handle various methods of electronic payment for consumer purchases. In addition to the common payment methods using credit cards or debit cards, some additional electronic payment methods include PayPal®, BillMeLater®, and Google Checkout™.

PayPal® provides an additional payment option for consumers on a merchant's website. With PayPal®, HTML forms are added to the merchant's website that direct the consumers to the PayPal® website for payment processing after which the consumer returns to the merchant's website. Merchants then have their PayPal® accounts credited with payment. Google Checkout™ adds a payment process to a merchant's website that simplifies the checkout process for both the merchant and the consumer. Google Checkout™ allows a consumer to make on-line purchases using a username and a password so that the consumer's credit card is charged and the merchant's bank account is credited with payment.

In another example, an on-line merchant using the BillMeLater® service incorporates an icon into the merchant's website in which the consumer can select the service as a payment option for a transaction. For example, FIG. 1A shows a merchant's webpage 10 having transaction information and a BillMe Later® icon 12, which is advertised to each consumer entering the screen. If the client selects the icon 12, then a new screen 20 in FIG. 1B allows the consumer to enter her billing address, date of birth, and last four digits of her social security number to register for the BillMeLater® service. Using the information entered, the BillMeLater® service contacts credit bureaus and obtains background information on the customer to determine whether to approve the transaction or not. If approved, the BillMeLater® service pays the merchant and separately bills the consumer for the transaction. In turn, the consumer can then pay the bill using a check, electronic funds transfer, or credit card.

With the growing popularity of on-line and other types of purchasing, merchants and consumers continue to seek new and useful ways to complete purchases electronically in addition to those already available.

### BRIEF DESCRIPTION OF THE DRAWINGS

FIGS. 1A-1B show screens of a web-based payment option according to the prior art.

FIG. 2 shows a web-based transactional credit system of the present disclosure.

FIG. 3 is a flow chart showing operation of the transactional credit system.

FIG. 4 shows a webpage requesting consumer demographic information for the transactional credit system.

FIG. 5 shows a webpage indicating pre-approval to the consumer of a transactional credit product.

FIG. 6 shows a webpage requesting additional consumer information to complete an instant credit application.

FIG. 7 is a flow chart showing operation of a transactional credit service when determining whether to offer a transactional credit product to the consumer.

FIG. 8 is a flow chart showing operation of the transactional credit service when determining whether to approve the transactional credit product.

FIG. 9 shows another transactional credit system of the present disclosure for handling web-based, phone, and retail transactions.

### DETAILED DESCRIPTION

In an automated transactional credit system, a consumer makes a purchase on a merchant's website. Before the consumer can select a payment option, a web page requests that the consumer enter her name and shipping or billing address. Using this information, the system uses a profiling mechanism to selectively offer the consumer with a credit product on a transactional basis. In an automated process, for example, the system first searches database information to determine whether the consumer has an existing account, an outstanding offer, a previously declined offer, etc. Next, the system applies various rules to the search results to determine whether to make an offer for a transactional credit product to the consumer. If the offer is to be made, the system then determines whether the consumer pre-qualifies for the transactional credit product using an on-line prescreen service.

If the consumer pre-qualifies, an additional webpage is incorporated into the merchant's website that offers the transactional credit product to the consumer to pay for the web-based transaction before the consumer is directed to any order confirmation or payment webpage on the website. If the consumer accepts the offer, the system performs any necessary authorization processes or instant credit applications and allows the consumer to pay for the web-based transaction with the newly acquired transactional credit product. In addition to being used for web-based transactions, the disclosed transactional credit system can be used for transactions over the phone (e.g., catalog orders), at a retail store, or via other channel.

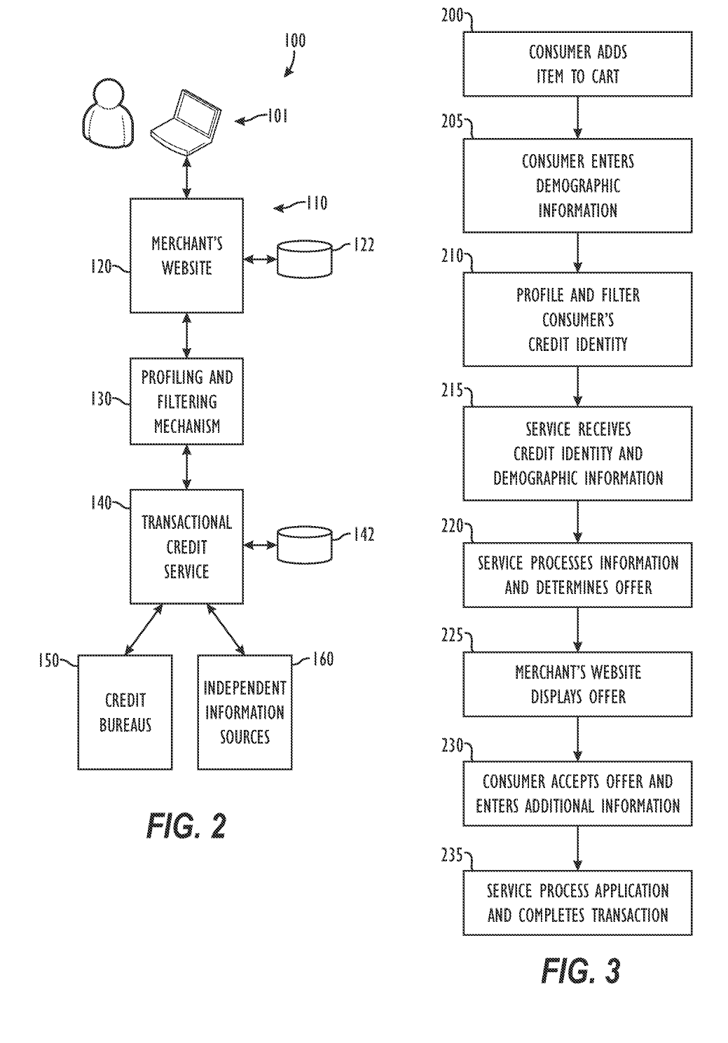

Turning to the drawings, a transactional credit system 100 is shown in FIG. 2 with its overall operation shown in the flow chart of FIG. 3. During a transaction, a consumer 101 using an Internet web browser accesses a website 120 of a merchant's system 110 and adds one or more items to an on-line cart (Block 200). At some point during or after the consumer has selected desired items to purchase, the merchant's website 120 directs the consumer to a webpage that requests the consumer's demographic information (e.g., name and shipping or billing address) (Block 205). Preferably, this request for information is done prior to the consumer being shown any payment options or being asked to select an option. By requesting demographics at this point in the transaction, the system 100 uses an atypical sequence for web-based purchases because the consumer's shipping or billing information is requested before the consumer actually enters any form of payment selection. As will be evidenced below, this atypical sequence is used to the systems advantage to prescreen the consumer for a transactional credit product before providing payment options to the consumer later in the transaction.

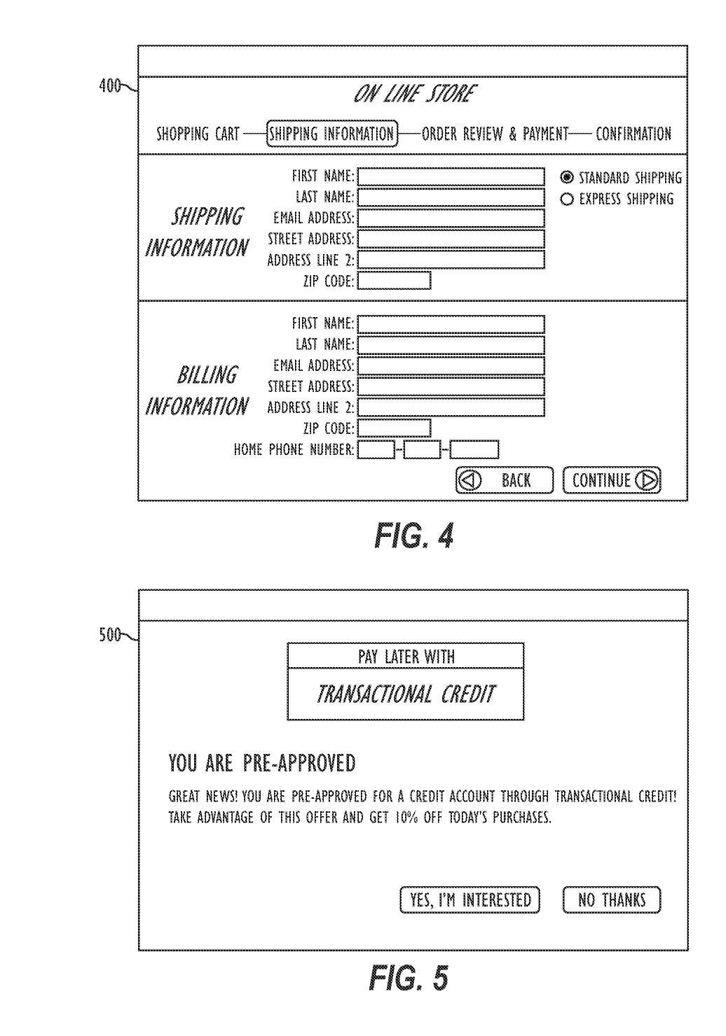

Briefly, FIG. 4 shows an example webpage 400 for obtaining the consumer's demographic information before allowing the user to make a payment selection. After reviewing a shopping cart showing selected items, for example, the consumer is presented with this shipping information the webpage 400 to enter some requested information. Preferably, the requested information at least includes the consumer's name and shipping and/or billing address but can also include the consumer's phone number, e-mail address, a client ID, or other identifying information.

As will be noted, however, the requested information at this point in the transaction processing does not include the consumer's date of birth or social security number. From her perspective, the consumer is merely entering her name and shipping or billing address to complete the web-based transaction and is not entering payment information or making any form of application for credit. As an alternative to requesting information in such a webpage 400, the system 100 can instead obtain the consumer's log-on ID for the merchant's website 120 and can use this to search its associated databases 122 for information pertaining to the consumer's identity.

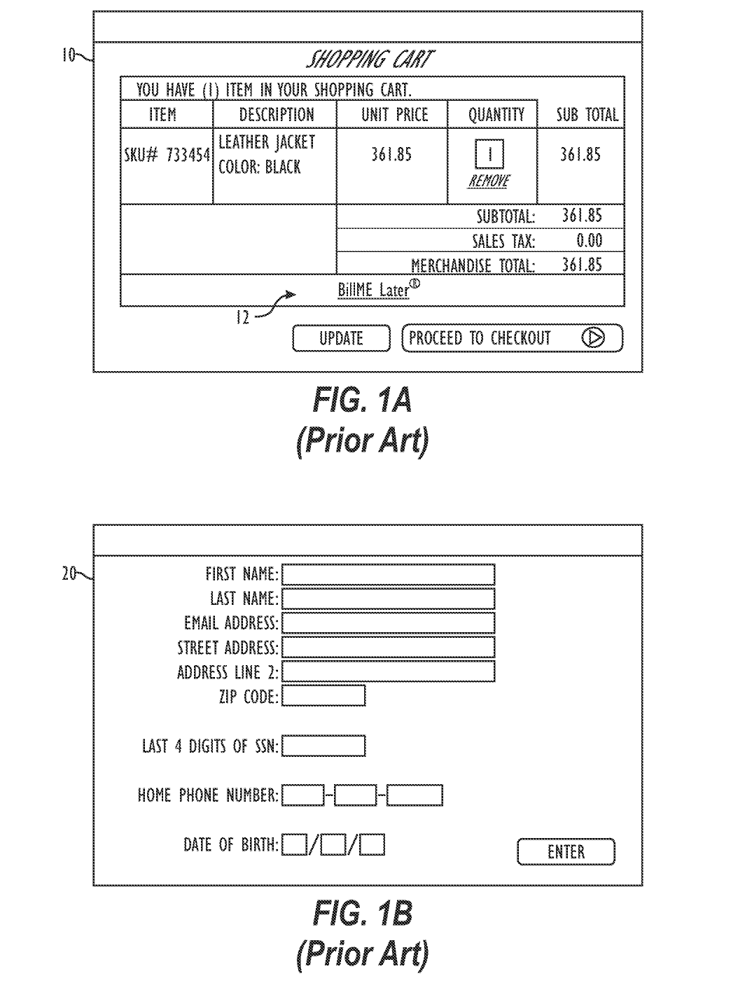

Returning to FIGS. 1 and 2, the merchant's website 120 uses the entered demographic information of the consumer to automatically search its associated databases 122 for stored information that matches the entered information. Using the search results, the merchant's website 120 determines a credit identity for the consumer. As noted below, this credit identity indicates whether the consumer has an existing account with a private label or co-branded credit product for the merchant, has an outstanding offer for such a product, has recently declined such an offer, etc.

Which credit identity a consumer has will determine whether the consumer's demographic information is sent to a transactional credit service 140 for processing and eventually will determine whether an offer for a transactional credit product will be made to the consumer to pay for the web-based transaction. In particular, a profiling and filtering mechanism 130 uses the consumer's credit identity and applies predetermined rules to filter out those web-based transactions where the consumer has one or more certain credit identities (Block 210). For example, the mechanism 130 may not send a consumer's information to the service 140 if the consumer already has a private label or co-branded credit account with the merchant or has an outstanding offer for such a private label or co-branded credit product. For these particular consumers, the merchant may wish to have the consumer use their existing private label or co-branded product or be reoffered such a product again as opposed to being offered a transactional credit product.

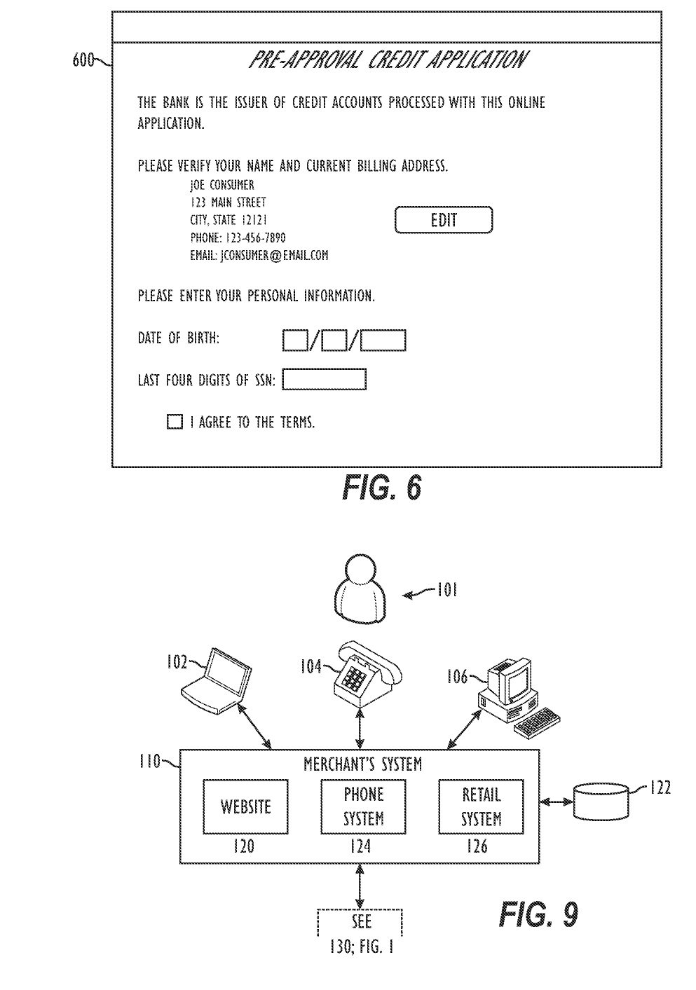

The profiling and filtering mechanism 130, however, transfers web-based transactions and demographic information that pass through the filtering to the transactional credit service 140 (Block 215). The service 140 then processes the consumer's demographic information and determines whether to offer the consumer a transactional credit product for the current web-based transaction (Block 220). This determination is also based on a set of rules and decisions, which are discussed in more detail later with reference to FIG. 6. In general, one rule may state that, if database information shows that the consumer has an existing offer for transactional credit, then the transactional credit system 100 provides that offer again to the consumer as part of the payment webpage that will follow on the merchant's website 120. If, on the other hand, no existing credit offer is found for the consumer, then additional rules may determine if a previous offer has been declined by the consumer and whether or not to make a new offer based on that determination.

After making a determination, the service 140 provides the result (offer, decline, etc.) to the website 120. If an offer is to be made, the offer is incorporated into the consumer's online experience on the merchant's website 120 and displayed to the consumer while proceeding from checkout to payment for the transaction (Block 225). If an offer is not to be made, then no additional webpage would be added to the consumer's on-line experience.

When an offer is made, the consumer is given an opportunity to accept the offer and then asked to enter additional information to complete the transaction (Block 230). For example, the additional information can be requested in a pre-approval credit application webpage 600 as shown in FIG. 6. The requested information can include the consumer's last four digits of her social security number and her date of birth to complete an on-line credit application. The service 140 uses the entered information to process the consumer's application and completes the transactions with the consumer's newly acquired transaction credit product (Block 235). The subsequent completion of the electronic transaction and handling of any returned items may be performed using the same infrastructure and techniques associated with private label credit cards and the like.

As an example of an offer, FIG. 5 shows a webpage 500 that may be presented to the consumer shortly after entering demographic information in the previous webpage 400 of FIG. 4. This webpage 500 provides details of the offer and a chance for the consumer to accept or decline the offer. Depending on various processing factors, the offer webpage 500 may be present promptly to the consumer on the merchant's website.

From the consumer's viewpoint, she has just entered her name and shipping and/or billing address on merchant's website in a webpage, such as in FIG. 4. If an offer is to be made, she will be presented with this offer webpage 500. The time frame in which the consumer is ultimately presented with the offer webpage 500 preferably accounts for only a small amount of time (e.g., 3 to 4 seconds) in the consumer's web-based experience and is preferably made before the consumer is presented with any payment options for the transaction. If additional processing time is needed to complete the determination to make an offer, the consumer may be presented with additional webpages in the web-experience that offer related products, promotional products, gift-related options, etc. For example, the merchant's website may automatically provide such webpages or may be designed to present them after a set amount of time has elapsed with no response from the transactional credit service 140. In any event, if the service 140 determines not to make an offer or fails to make the determination, the consumer will not be presented with a decline webpage. Instead, she will be presented with an order confirmation and payment webpage on the merchant's website 120 just as during any typical on-line transaction.

In one implementation of the transactional credit system 100 of FIG. 1, any servers, databases, and other components hosting the transactional credit service 140 may be independent from any components hosing the merchant's website 120. In such a case, the transactional credit service 140 can provide services for transactional credit products to a number of different merchant websites. In an alternative implementation, associated components may provide both the website 120 and the service 140 together. In addition, operational details of the profiling and filtering mechanism 130 discussed previously may be handled by the merchant's website 120 alone, the transactional credit service 140 alone, or shared between them.

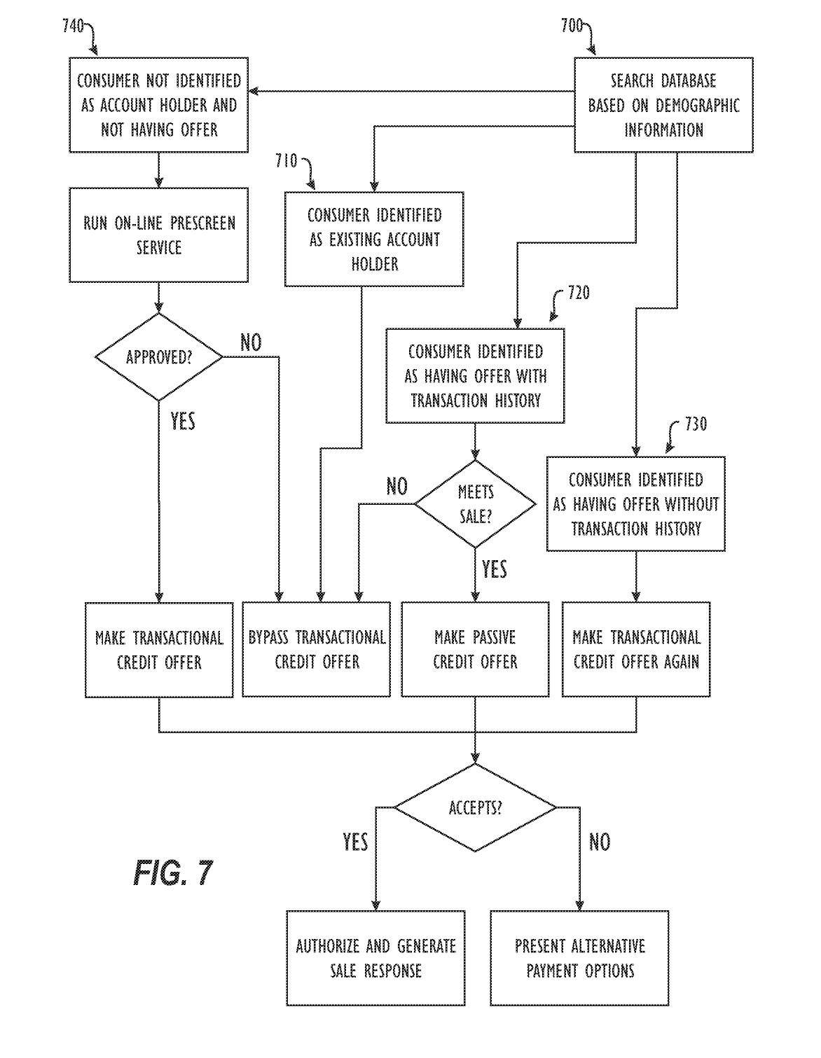

Regardless of the particular implementation, FIG. 7 shows a flow chart providing additional details how the transactional credit system determines whether to offer a transactional credit product to a consumer. At the outset in the determination, database information is searched based on the consumer's demographic information (e.g., name, shipping address, billing address, and phone number; See e.g., FIG. 4) to determine the consumer's credit identity (Block 700). Essentially, a given consumer in the on-line transaction at the merchant's website may have one of four credit identities.

In a first identity, for example, the search may identify the consumer as having an existing account (Block 710). This account could include an existing merchant private label or co-branded credit product, which the merchant would then prefer the consumer use to complete the transaction. In addition, the existing account could include an existing transactional credit product previously accepted by the consumer. In either case, the entire offer of a transactional credit product may be bypassed for this consumer, and the merchant's website can direct the consumer to an order confirmation and payment webpage.

In a second identity, for example, the search may identify the consumer as having a previous offer for transactional credit with transaction history (Block 720). Here, a determination can be made whether the consumer's current transaction meets any sales limits or requirements for such an offer. In addition, a determination can be made whether the consumer's previous transaction history supports a current authorization of a credit product. If the requirements are not satisfied, the entire offer of a transactional credit product will be bypassed altogether. If the requirements are satisfied, a passive transactional credit offer can be made to the consumer in the form of an advertisement, logo, or additional payment option for the transactional credit product. Such a passive offer can be incorporated into an order confirmation and payment webpage presented to the consumer on the merchant's website.

In a third identity, for example, the search may identify the consumer as having a previous offer for transactional credit without any previous transaction history from which to base a negative authorization (Block 730). In this situation, the transactional credit offer can be made again to the consumer using an offer webpage such as shown in FIG. 5.

Finally, in a fourth identity, for example, the search may identify the consumer as a virgin consumer who does not have an existing account or a previous offer for the transactional credit product (Block 740). Here, the transactional credit service 140 has a mechanism that runs an on-line prescreen service to determine whether the consumer is pre-approved or not. If pre-approved, an offer for a transactional credit product is made. The on-line prescreen service can be similar to those known in the art. As shown in FIG. 2, for example, the transactional credit service 140 can consult its associated databases 142, credit bureaus 150, and other sources 160 of information to make the prescreen determination on-line. Typically, the prescreen service uses techniques for verifying the consumer's information, scoring that information, and analyzing the risks involved in offering credit to the consumer based on the information.

As detailed above, which identity the consumer has determines whether or not an offer is made to the consumer and how that offer may be made to the consumer. Ultimately, if the consumer receives an offer for transactional credit, she may either accept or reject it, and processing proceeds accordingly, as shown at the bottom of FIG. 7. Those consumers accepting the offer will be presented with a webpage for completing a pre-approval credit application, such as webpage 600 in FIG. 6, where the consumer may finally enter such information as date of birth and social security number.

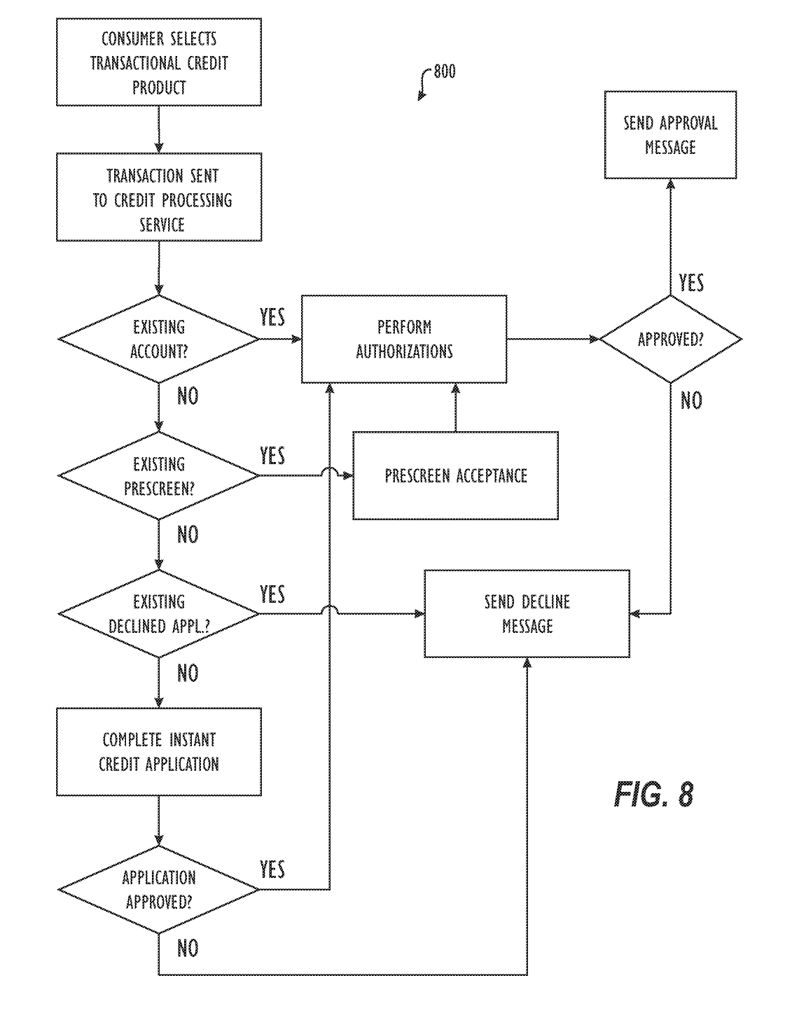

After accepting the offer, entering the additional information, and agreeing to the terms, the transactional credit service performs a credit processing service. For example, FIG. 8 is a flow chart showing various decisions and operations for a credit processing service 800. In general, this service 800 may be performed solely by the transactional credit service (140; FIG. 2) discussed previously or may be performed independently by another entity so that it may make some duplicate determinations. The credit service 800 decides whether the consumer has an existing account, went through a previous prescreen process, had a previously declined application, etc. Depending on the circumstances, the service's authorization rules may be applied or an instant credit application may be completed to determine whether to approve or decline the transactional credit product. These various determinations use such information as the consumer's name, demographics, date of birth, social security number, credit report, credit score, etc.

Ultimately, the approved transactional credit product is used to complete the consumer's transaction on the merchant's website using credit payment techniques. For example, the transaction credit service (140; FIG. 2) may be associated with banks or other institutions to underwrite transactional credit accounts and to fund the web-based transactions. In addition, the transactional credit service may also provide account management services via a website for the merchant, consumer, or both. In some arrangements, a physical credit card may not be sent to the consumer upon completion of the transaction with the transactional credit product. In addition, the consumers may not be provided information about a credit limit, available credit, or what would be open to purchase with the credit product since the product is based on individual transactions.

As opposed to handling only web-based transactions, the transactional credit system 100 in general can be configured to handle one or more types of electronic transactions through different channels, including web, phone, and retail. For example, FIG. 9 shows the system 100 having components for handling phone and retail transactions in addition to the previously described web-based transactions. To handle the web-based transactions, the merchant's system 110 again has the merchant's website 120 that interfaces via the Internet with a consumer's computer 102 and processes web-based transactions and transactional credit in the same way discussed previously.

Providing additional channels, the merchant's system 110 also has a phone system 124 for interfacing with telephones 104 and has a retail system 126 for interfacing with retail devices and systems 106. These additional systems 124 and 126 can process consumer's electronic transactions in much the same way discussed above with reference to the web-based transactions. Moreover, these additional systems 124 and 126 can obtain the consumer's name and shipping or billing address before allowing the consumer to select a payment option so the system 100 can first determine whether to offer the consumer a transactional credit product in much the same manner as that discussed above with reference to web-based transactions.

For example, the phone system 124 can include an Interactive Voice Response (IVR) or touch-tone response system that handles consumers' catalog orders made in phone calls to the phone system 124. Details of an automated phone system are provided in co-pending U.S. application Ser. No. 10/176,167, which is incorporated herein by reference in its entirety. When a consumer is making a catalog order over the phone, part of the catalog transaction handled by the phone system 124 can involve obtaining the consumer's name and shipping or billing address. The phone system 124 obtains this demographic information from the consumer via the phone 104 before allowing the consumer to select a payment option for the transaction and without requesting typical credit related information such as digits from the consumer's social security number or date of birth. Based on the obtained demographic information, the transactional credit system 100 can the determine whether to offer the consumer a transactional credit process in a manner similar to that discussed above with reference to web-based transactions.

In another example, the retail system 126 can interface with computers, registers, and other retail devices 106 at retail outlets or stores. When a consumer is making a purchase at the retail outlet, part of the retail transaction can involve obtaining the consumer's name and shipping or billing address. As with the web and phone based systems, the retail system 126 can obtain this demographic information from the retail devices 106 before the consumer is made to select a payment option. For example, a clerk at a retail register may request the consumer's name and address as part of the transaction, or the clerk may request the consumer's phone number, which is then used to find any previously stored demographic information on the consumer. Using the demographic information relayed from the retail system 126, the transactional credit system 100 can then determine whether to offer the consumer a transactional credit process in a manner similar to that discussed above with reference to web-based transactions.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. An automated transactional credit method, comprising:
receiving purchase information for an electronic transaction;
receiving demographic information for a consumer of the electronic transaction before allowing the consumer to make a payment selection for the electronic transaction, the demographic information pertaining to a name and an address of the consumer;
using the demographic information to determine electronically in an automated process whether the consumer pre-qualifies for a transactional credit product;
offering the transactional credit product to the consumer to pay for the electronic transaction if the consumer pre-qualifies; and
receiving a response to the offer from the consumer.

2. The method of claim 1, wherein using the demographic information to electronically determine in an automated process whether the consumer pre-qualifies comprises running an on-line prescreen service to determine qualification.

3. The method of claim 1, further comprising processing an instant credit application based on an affirmative response to the offer.

4. The method of claim 1, wherein the electronic transaction comprises a web-based transaction, and wherein receiving demographic information comprises providing a webpage in a website of a merchant that requests the demographic information before the consumer is allowed to make a payment selection on the website.

5. The method of claim 4, wherein offering the transactional credit product comprises incorporating the offer into the website of the merchant before allowing the consumer to make a payment selection of the website.

6. The method of claim 1, wherein the electronic transaction comprises a web-based transaction, a phone-based transaction, or a retail-based transaction.

7. A program storage device, readable by a programmable control device, comprising instructions stored on the program storage device for causing the programmable control device to perform a method according to claim 1.

8. An automated web-based transactional credit method, comprising:
receiving purchase information for a web-based transaction;
receiving demographic information for a consumer of the web-based transaction before allowing the consumer to make a payment selection for the web-based transaction, the demographic information pertaining to a name and an address of the consumer;
using the demographic information to determine a credit identity for the consumer;
using the credit identity to determine whether to make an offer for a transactional credit product to the consumer;
using the demographic information to determine electronically in an automated process whether the consumer pre-qualifies for the transactional credit product if the offer is to be made;
offering the transactional credit product to the consumer to pay for the web-based transaction if the consumer pre-qualifies; and
receiving a response from the consumer to the offer.

9. The method of claim 8, wherein using the demographic information to determine the credit identity comprises searching database information for a match to the obtained demographic information.

10. The method of claim 9, wherein the database information comprises names, addresses, indications of accounts, indications of outstanding offers of credit products, and indications of declined credit offers.

11. The method of claim 8, wherein using the credit identity to determine whether to make the offer comprises determining whether the consumer has an outstanding offer for a credit product.

12. The method of claim 8, wherein using the credit identity to determine whether to make the offer comprises determining whether the consumer has a previous offer for a credit product that the consumer has declined.

13. The method of claim 12, wherein offering the transactional credit product comprises making a passive offer for the transactional credit product to the consumer when the consumer makes a payment selection for the web-based transaction.

14. The method of claim 13, wherein making the passive offer comprises incorporating a logo, an advertisement, or a payment option for the transactional credit product on a webpage of a website of a merchant that allows the consumer to select payment.

15. The method of claim 8, wherein using the credit identity to determine whether to make the offer comprises determining whether the consumer has an existing account, and wherein the method comprise bypassing the acts of offering the transactional credit product to the consumer and receiving a response from the consumer.

16. The method of claim 8, wherein using the demographic information to determine whether the consumer pre-qualifies comprises running an on-line prescreen service to determine qualification.

17. The method of claim 8, wherein offering the transactional credit product to the consumer comprises incorporating the offer into a web-based page on a merchant's website before allowing the consumer to make a payment selection on the merchant's website.

18. The method of claim 8, further comprising processing an instant credit application based on an affirmative response from the consumer to the offer.

19. A program storage device, readable by a programmable control device, comprising instructions stored on the program storage device for causing the programmable control device to perform a method according to claim 8.

20. An automated transactional credit system, comprising:
one or more databases having database information, the database information including one or more of accounts, names, addresses, previous credit offers made, and previous credit offers declined for consumers;
an electronic communication mechanism receiving information for an electronic transaction of a consumer and obtaining demographic information of the consumer prior to allowing the consumer to make a payment selection for the electronic transaction, the demographic information pertaining to a name and an address of the consumer;
a profile mechanism receiving the demographic information and searching the one or more databases to determine a credit identity for the consumer; and
a prescreen mechanism having one or more rules, the prescreen mechanism receiving the demographic information, credit identity, and electronic transaction information, the prescreen service applying the one or more rules to the received information and determining whether the consumer pre-qualifies for a transactional credit product, the prescreen mechanism communicating a transactional credit product offer to the electronic communication mechanism if the consumer pre-qualifies,
wherein the electronic communication mechanism communicates the offer to the consumer and receives a response prior to allowing the consumer to make a payment selection for the electronic transaction.

21. The system of claim 20, wherein the electronic communication mechanism comprises one or more webpages incorporated into a merchant's website.

22. The system of claim 20, wherein the profile mechanism comprises a filter determining whether to transfer information to the prescreen mechanism based on the consumer's credit identity.

23. The system of claim 20, wherein the filter determines not to transfer information for those consumers having existing private label or co-brand accounts with a merchant.

24. The system of claim 20, wherein the filter determines not to transfer information for those consumers having existing credit offers made for a private label or co-brand credit product with a merchant.

25. The system of claim 20, further comprising an instant credit application mechanism initiating an instant credit application based on an affirmative response from the consumer to the transactional credit product offer.
